(19) United States
(12) Patent Application Publication
(10) Pub. No.: US 2010/0228415 A1
(43) Pub. Date: Sep. 9, 2010

(54) SYSTEM AND METHOD FOR REDUCING THE COST OF EFFICIENT VEHICLES

(76) Inventor: SUNIL PAUL, San Francisco, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/717,852

(22) Filed: Mar. 4, 2010

Related U.S. Application Data
(60) Provisional application No. 61/157,605, filed on Mar. 5, 2009.

(51) Int. Cl. B60W 20/00; B60L 3/12; G06Q 10/00; G06Q 30/00; G06Q 50/00; G06F 15/16; G06F 17/30

(52) U.S. Cl. 701/22; 701/123; 705/30; 705/34; 903/903; 709/227; 707/802; 707/E17.044

(57) ABSTRACT

A system and method are described for reducing the cost of efficient vehicles. For example, a computer-implemented system according to one embodiment of the invention comprises: a vehicle equipped with a memory for storing program code and a processor for processing the program code to perform a specified set of operations, the vehicle further comprising a data communication interface; a fuel pump of electrical charging station having a data communication interface, wherein the fuel pump of electrical charging station and the vehicle establish a digital data communication channel using the data communication interfaces as the vehicle is being refueled or charged; wherein the fuel pump of electrical charging station provides an amount of fuel or electricity to the vehicle and, after or during fueling or recharging, transmits an indication of the amount of fuel or electricity consumed by the vehicle to a third party server; wherein the third party server is maintained by a third party having a contractual relationship with an owner/operator of the vehicle in which the vehicle has been provided to the owner/operator at a reduced cost in exchange for an agreement by the owner/operator to provide the third party a supplemental payment based on the amount of fuel or electricity consumed by vehicle, wherein in response to receipt of the indication of the amount of fuel or electric consumed by the vehicle, the third party charges the owner/operator a supplement amount based on the amount of fuel or electricity used by the owner/operator.

### CLAIM TO PRIORITY

This application claims priority to U.S. Provisional Application Ser. No. 61/157,605, filed, Mar. 5, 2009, entitled, “System and Method For Reducing The Cost of Efficient Vehicles”.

### BACKGROUND OF THE INVENTION

1. Field of the Invention

This invention relates generally to the field of network transaction services. More particularly, the invention relates to an improved system and method for reducing the cost of efficient vehicles.

2. Description of the Related Art

Fuel economy and lower carbon footprints are an increasing concern for automobiles. There are many ways to improve the efficiency of automobiles and other transportation products, but typically they require a significant up-front capital expense. Often these vehicles are inexpensive to operate, but even with quick payback, consumers and businesses are reluctant to purchase these more efficient products.

### BRIEF DESCRIPTION OF THE DRAWINGS

A better understanding of the present invention can be obtained from the following detailed description in conjunction with the following drawings, in which:

FIG. 1 illustrates an exemplary network architecture used to implement elements of the invention.

FIG. 2 illustrates an exemplary computer system for implementing embodiments of the invention.

FIG. 3 illustrates a particular network architecture for implementing embodiments of the invention.

### DETAILED DESCRIPTION OF PREFERRED EMBODIMENTS

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Embodiments of the present invention include various steps, which will be described below. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The techniques described below enable consumers to pay lower up-front prices in exchange for slightly higher prices during the operation of the vehicle. While described below for automobiles, these techniques can be applied to any product or service that is characterized by an up-front capital expense and an ongoing service expense such as fuel or electricity. They can also be used when an up-front capital expense is required and a periodic service interaction is required such as regular maintenance. Also note that while the embodiments of the invention described herein describe price premiums to offset up-front capital expense, different embodiments may also be applied to price discounts or surcharges that may be offered for various reasons (e.g. promotion, bulk purchase, affinity marketing, customer loyalty, government mandates, financial instrument such as derivatives).

### An Exemplary Network Architecture

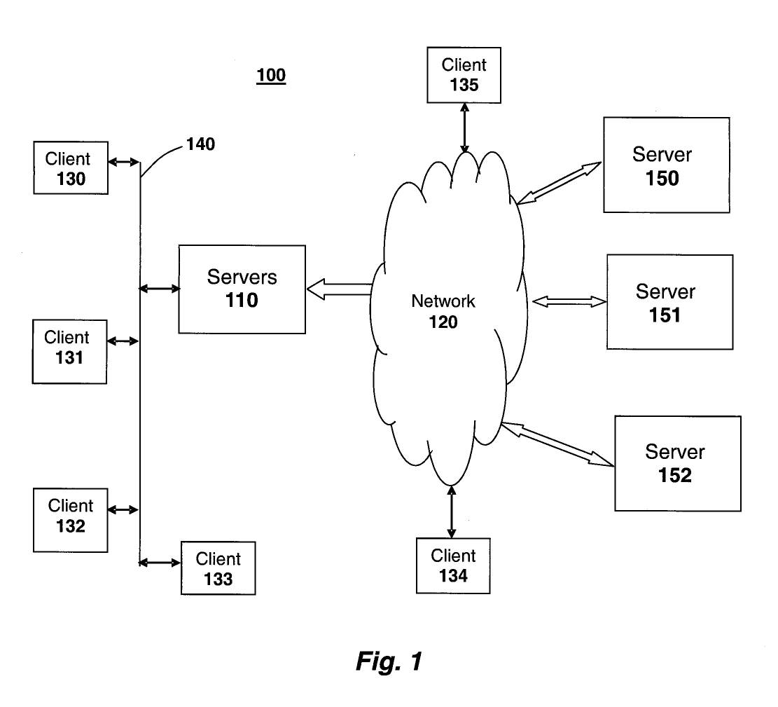

Elements of the present invention may be included within a client-server based system 100 such as that illustrated in FIG. 1. According to the embodiment depicted in FIG. 1, one or more servers 110 communicate to a plurality of clients 130-135. The clients 130-135 may transmit and receive data from servers 110 over a variety of communication media including (but not limited to) a private network 140 (e.g., a local area network) and/or a public network 125 (e.g., the Internet). In some of the embodiments described below, the clients 130-135 are automobiles equipped with a wireless (RF) or wired communication interface. Alternative communication channels such as wireless communication via satellite broadcast (not shown) are also contemplated within the scope of the present invention.

Servers 110 may include a database (not shown) for storing various types of data. This may include, for example, specific client data (e.g., client account information and client preferences) and/or more general data. The database on servers 110 in one embodiment runs an instance of a Relational Database Management System (RDBMS), such as Microsoft™ SQL-Server, Oracle™ or the like.

A user/client may interact with and receive feedback from servers 110 using various different communication devices and/or protocols. According to one embodiment, a client connects to servers 110 via client software. The client software may include a browser application such as Mozilla Firefox™ or Microsoft Internet Explorer™ on the user's personal computer which communicates to servers 110 via the Hypertext Transfer Protocol (hereinafter “HTTP”). In this embodiment, the servers 110 include Web servers. In other embodiments included within the scope of the invention, clients may communicate with servers 110 via cellular phones and pagers (e.g., in which the necessary transaction software is embedded in a microchip), handheld computing devices, and/or touch-tone telephones.

Servers 110 may also communicate over a larger network (e.g., network 125) to other servers 150-152. Together, the servers 110, 150-152 include program code for performing the steps described below. It should be noted, however, that the underlying principles of the invention are not limited to any particular hardware/software implementation.

### An Exemplary Computer Architecture

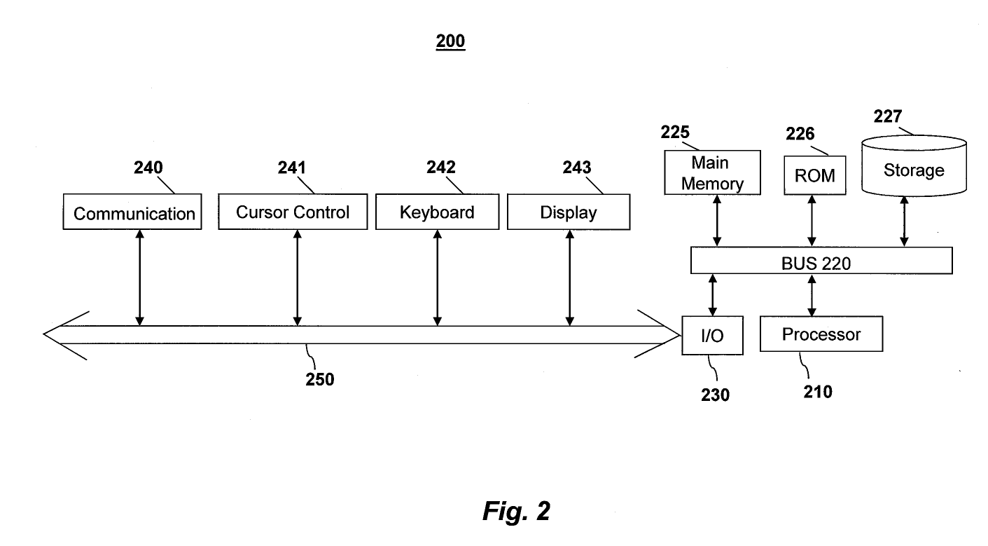

Having briefly described an exemplary network architecture which employs various elements of the present invention, a computer system 200 representing exemplary clients 130-135 and/or servers (e.g., servers 110), in which elements of the present invention may be implemented will now be described with reference to FIG. 2.

One embodiment of computer system 200 comprises a system bus 220 for communicating information, and a processor 210 coupled to bus 220 for processing information. Computer system 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Computer system 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Computer system 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, video news clips and related information may be presented to the user on the display device 243.

The communication device 240 is for accessing other computers (servers or clients) via a network 125, 140. The communication device 240 may comprise a modem, a network interface card, or other well known interface device, such as those used for coupling to Ethernet, token ring, or other types of networks.

### Embodiments of the System and Method for Configuring and Distributing Automobiles

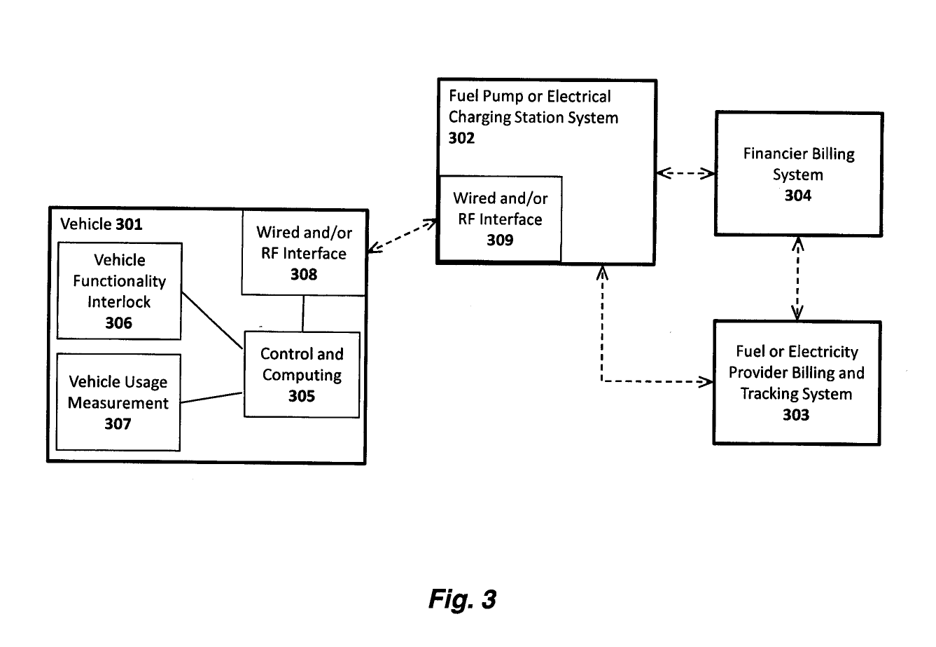

As illustrated in FIG. 3, in one embodiment of the invention, vehicles 301 with are equipped with data processing and communication functionality. Specifically, in the embodiment shown in FIG. 3, the vehicle 301 includes a vehicle functionality interlock module 306, vehicle usage measurement module 307, control and computing module 305 and a wired and/or RF interface module 308. Each of these modules may be implemented with hardware, software or any combination thereof.

In one embodiment, the vehicle usage measurement module 307 continually monitors and records vehicle usage data including, but not limited to, miles driven, power consumed, and/or power input to the vehicle. This information is provided to the vehicle functionality interlock module 306 which limits functionality or disables use of the vehicle in certain circumstances (as described herein). Both the vehicle functionality interlock 306 and the vehicle usage measurement module 307 operate under control of the computing module 305. In one embodiment, each of these modules is implemented as software executed on a general purpose processor such as an x86 processor designed by Intel Corporation. However, the underlying principles of the invention are not limited to any particular hardware or software configuration.

In the embodiment shown in FIG. 3, a communication channel is established between the vehicle 301 and a fuel pump or electrical charging station system 302 through communication interfaces 308 and 309. As indicated in FIG. 3, the communication interfaces may be wireless (e.g., 802.11n) or wired (e.g., Ethernet). In addition, the fuel pump or electrical charging station system 302 communicates with a financier billing system 304 and a fuel or electricity provider billing and tracking system 303. The communication financier billing system 304 and fuel or electricity provider billing and tracking system 303 may also communicate directly, as indicated. Communication between each of the entities shown in FIG. 3 may be over the Internet or over a private network (e.g., a LAN or WAN).

In one embodiment, data is exchanged between each of the systems shown in FIG. 3 as follows:

Data from the vehicle 301 transmitted via the network interface 308 to the electrical charging or fuel pump 302 includes ID code(s) to indicate the identity of the vehicle being fueled or charged (e.g., the Vehicle Identification Number or other code to uniquely identify the vehicle); status codes; identification data identifying components on the vehicle such as the battery pack; usage and charging data; temperature profile data; and/or driver profile data.

Data from the from the electrical charging or fuel pump station system 302 to the vehicle 301 includes the amount of fuel or electricity which was loaded into the vehicle; the price charged including both the base price at the pump or at the meter as well as the supplement; and/or a special code that enables use of the vehicle for a specific amount of time or miles or other usage metric.

Data from the charging/fueling system 302 to the financier billing system 304 can optionally be intermediated by a charging/fueling billing system 303. Data transmitted from 302 to 304 (alternatively intermediated by 303) may include: identification codes of vehicles charged/fueled; data indicating the amount of electricity/fuel dispensed; identifications of vehicles in disabled/alert status; and information about vehicle characterization.

Data from the charging/fueling billing system 303 to the financier billing system 304 may include: data indicating the location of the charging/fueling station and/or other status information.

An alternative embodiment to having an intermediary 303, is to use the vehicle's GPS or other location technology (not shown) to identify the location of the refueling/recharging site 302. The pump, 302, or the wired/wireless network interface 309, may also include location technology and provide similar information.

In one embodiment, when a user initially purchases an energy-efficient car, the user pays less than the market value for the car. For example, this car, if purchased according to today's system of auto sales, might cost $30,000. Instead, when implementing the embodiments of the invention described herein, the user pays a specified percentage less (e.g., $20,000) for the car. At the time of sale, the user registers her vehicle with the financier billing system 304 which is continuously provided vehicle usage notifications. For example, at home, when the user plugs her car into her home garage outlet, an identification code is transmitted to the financier billing system 304 (e.g., over the user's home wireless/wired Internet connection). At the end of the month, the user receives a bill that charges the user an additional amount as a supplemental car charging payment. When the user stops at a gas station to fill her vehicle, the RF interface in her car and the pump recognizes that she is to pay a supplemental fee for gasoline, so instead of paying $1.75 per gallon, she pays $1.99 per gallon. In one embodiment, an identification code uniquely identifying the vehicle (e.g., a VIN or similar code) is transmitted from the network interface 308 of the vehicle 301 to the network interface 309 of the fuel/charging station system 302, which then forwards the vehicle's identity to the financier billing system 304 or the billing and tracking system 303. The supplemental fee amount is then calculated based on the identity of the vehicle and communicated from the financier billing system 304 or the billing and tracking system 303 to the fuel pump/electrical charging station 302.

In one embodiment, unless the vehicle is registered with the financier billing system 304, it cannot be charged or pumped with gasoline. When the user sells her car, the new owner registers his own credit, home address, and payment information with the financier billing system 304, so he can use the charging system at home and when he travels. If the new owner tries to evade the system by pumping gas from an out-of-network pump, the vehicle reports the abuse to the financier billing system 304, for a warning. If the warnings are ignored, then various steps may be taken such as rendering the vehicle less useful and/or inoperable.

As described above, one way to implement this embodiment of the invention is to use an RF interface 308 that communicates between the vehicle 301 and the financier system 304. This system works regardless of the fueling mode as long as the vehicle is properly outfitted with sensors to detect charging and fuel tank levels.

There are at least three potential types of vehicles that are equipped to take advantage of the embodiments of the invention described herein (although any type of vehicle or capital good may be used):
1. an all-electric vehicle that is recharged through an electrical plug
2. an all-gas or other fuel vehicle that is refueled by filling a tank
3. a plug-in hybrid electric vehicle (PHEV) that can operate off either an electric charge from a plug or from a fuel-powered engine.

Each case described below employs slightly different adaptations.

I. Embodiments for all-Electric Vehicles
a. Charging at a location that is also the owners' location:
   i. The owner receives a bill from their utility as they would otherwise. In one implementation, they see a separate charge attributed to their electrical vehicle. This is effected by the utility receiving an identification code and data indicating the amount of power consumed. The supplemental fee information is provided by the financier billing system 304.
   ii. In an alternative embodiment, the vehicle owner receives a standard bill from the utility and a separate bill from the financier.
b. Charging at a location that allows for “free” charging (e.g. a municipal lot or employee's lot) or a location that charges separately for charging:
   i. In one embodiment, the vehicle owner receives a bill from the utility that identifies when and where they charged their vehicle. Because this is a case where the charging was free, the only fee is the financier supplement (as described above).
   ii. In an alternative embodiment, the vehicle owner receives a separate bill for the supplement. For this alternative, there are two options:
      1. First, the owner only receives the supplemental bill for charges outside the home location(s). This version might be implemented in cases where the home location(s) have utility-based billing for the premium.
      2. In another embodiment, the owner receives supplemental bills for all charging. In other words, it is easier for the consumer to understand a single source of billing for a service (charging the vehicle) rather than two separate billings that depend on where the vehicle is charged.
c. Charging at a location that requires full reimbursement:
   i. This case requires additional information and billing sophistication by the utility or electricity service provider. The ideal embodiment requires that the utility provide a credit back to the charging site provider on their electrical bill with the option for them to add their own markup fee on the charging. Those fees then show up on the vehicle owner's electrical bill. These billing services for the utility could be provided by a third party, which might be the financier.
   ii. In an alternative embodiment, the financier billing system receives information about the power consumed by the charging of the vehicle and provides that amount of credit or payment to the charging site. As in the previous embodiment, the charging site has the option to charge a premium. The vehicle owner then receives a bill for the supplemental fee.
   iii. In an alternative embodiment, the charging site requires full payment at the time of purchase. This can be accomplished most easily with a direct interface with the financier billing system. The charging site owner then pays the electrical utility its usual rate and gets a fee from the users of the charger, with or without a premium.
d. Charging is done by a battery owner/operator and swapping service (BOOSS). One example is the company Better Place, that expects to launch its “mobility operator” service in Israel, Denmark, and elsewhere. Existing service providers operate under the premise that they will bundle the role of financing, battery owner and operations, and charging site together using the cell phone service providers as their model. The current invention is a better implementation of those ideas by allowing the functions to be separated. However, the two can be combined in the following way:
   i. In one embodiment, the financier and the BOOSS are combined and the financier function is a way for the BOOSS to extend its network.
   ii. In one embodiment, the BOOSS operates as a franchise to the financier and is responsible for the operation, maintenance, and servicing of the battery packs. The financier provides financing and billing technology to enable the service. The financier may also provide the other attributes commonly found in franchise systems (branding, marketing, common purchase, etc) although these are a separate business decisions not pertinent to the invention. In this embodiment, the franchisee operates in a manner that is consistent with (c) above.
   iii. One embodiment allows for the cases when a BOOSS can leave their batteries in a vehicle and receive compensation for their use. Such a system has a separate code for that identifies the battery pack owner to the charging station system. This information when coupled with information from the financier billing system can result in a separate premium being charged. Thus a system of competitive BOOSS can be created that is decoupled from the system in the automobile. A different rate can be paid by the consumer depending on which BOOSS battery pack is installed in the vehicle.
e. The owner uses a charging system that isn't part of the network connected to the financier. The simplest business solution, of course, is to just not allow such connections. But it is likely that in the early stages of deployment of a network to support other embodiments, there will be charging locations outside the network.
   i. One embodiment allows for out of network charging and then charges the owner for the supplement. Generally, this requires a network communications path back to the financier to report the amount of power used or alternatively the number of miles driven.
      1. One embodiment uses a communication means in the vehicle that provides a tamper-resistant interlock 306 which operates based on data collected by the vehicle usage measurement module 307. This data may include, for example, mileage, power usage, or the amount of power used to charge the vehicle. Collectively, this is referred to as “usage data.” It also has a communication means that can communicate outside the vehicle to commonly accessible networks such as wireless networks (e.g. cell towers, WiFi, paging systems, satellite networks, WiMax, Bluetooth, infrared)
         a. In this embodiment, the external communication means transmits the usage data when it is in communication range and according to its programmed schedule. The financier billing network receives this data and uses it prepare a bill to the owner.
         b. In one embodiment, this external communication means also transmits information about the identity of the charging locations so these owners can be either be included in the report or compensated for the charging.
         c. In one embodiment, the user still receives a single bill for vehicle charging either from the utility or from the financier. Providing a monthly fee adjustment based on the number of miles driven may be accomplished through an RF or wired reporting of miles driven. The reporting mechanism may also include data on power consumed and/or power added to the vehicle.
         d. The reporting method may be a delayed communication of usage data when the vehicle is next able to communicate to the financier network. An option for this embodiment includes limits on the use of the vehicle outside the network. These limits may be implemented by use of public key infrastructure as known in the art. The expiration of these keys may cause some level of disability in the use of the vehicle.
      2. An alternative embodiment uses remote detection technologies such as license plate recognition, body-mass profiling, RF signatures, remote imaging (satellite and/or high altitude aircraft) and others that may become known. This embodiment uses these technologies to detect owners who are using their vehicles and the number of miles being driven. Such embodiments may also be coupled with others mentioned here to limit efforts to bypass the interlock system.
      3. Another embodiment to limit bypassing the interlock system 306 is to track electronic credit reports, car registration databases, driver license databases, and other online databases to detect that an owner has moved to a location with limited access to either the financier billing network or the fail-safe network depending on the embodiment of the financier system.
   ii. There is, however, an embodiment that requires no communications path back to the financier. It is implemented as a fail-safe mechanism to limit the temptation to bypass the interlock system.
      a. One embodiment is to charge a basic amount on a lease for each mile driven unless the financier billing system shows those miles were paid for. Another embodiment provides a penalty for miles not paid for. This is implemented over the internet using electronic contracts and/or payments.
      b. Another embodiment is to charge a monthly fee for the use of the vehicle. At its simplest embodiment, this is just another fee in addition to the lease or loan fee that amortizes the capital costs. Another embodiment adjusts the monthly fee depending on the amount of electricity and/or fuel consumed. These embodiments would be best implemented over the Internet using automated billing as is known in the art.

### II. Embodiments for Gas-Powered Vehicle

This system may be especially attractive to field expensive fuel economy technologies such as electric hybrids, advanced diesel, or just used to reduce the cost of buying a car. A significant piece of prior art are payment cards for fuels that bill a third party based on a card presentation (swiping) at the pump and information about the vehicle (ID code, mileage, etc). One embodiment uses a limited number of refueling stations that charge a supplement for refueling. But other embodiments are also contemplated which provide broader access to refueling stations.
a. All of these embodiments require some method for transferring information between the vehicle and the pump.
   iii. One embodiment requires a communication path between the vehicle and the pump. A code is passed to the pump that indicates the vehicle requires a premium price for its fuel. The pump then adjusts the price per gallon or other price premium. The code can be passed via an RF or wired interface or other communications means as may become available.
   iv. An alternative embodiment requires that the vehicle driver use a special payment card that requires a code to activate the pump. This may also be tied to the vehicle owner/driver's credit card.
   v. An alternative embodiment requires an interlocking codes between the vehicle and pump that enable operation of the vehicle and pump. For example, the vehicle generates a public key—ideally translated into a pseudo-word like “GRUMPGO” or into an easy to remember combination like 4422—that the driver enters into the pump.
   vi. An alternative embodiment allows for the pump to charge the same amount as for other vehicles, but charges the vehicle separately for the premium. This charge back to the owner can be via a premium charged to the credit or debit card, a separate bill to the user via the financier billing system.
b. An alternative embodiment uses a physical interlock between the pump and the vehicle. As is known in the art, a physically compatible fuel feeding system that only couples with a fuel receiving system can be used to restrict the types of fuel(s) that enter a vehicle. A common example of such an interlock is the different size nozzles used for diesel and gasoline to avoid mixing the two fuels. In this embodiment, pumps with the physical interlock charge a different price than a standard pump. This embodiment can be combined with many of the previous embodiments described for this case.
c. All of these embodiments require some method to minimize drivers who evade the system and use fuel from outside the network. There are several ways to discourage cheats that could be used individually or in some combination.
   vii. A special code token is required to operate the vehicle. These codes are delivered to the vehicle using various means but when delivered enable the vehicle to operate for some duration that could include (but not limited to):
      1. Time period
      2. Miles driven
      3. Until a sensor detects another tank filling
   viii. When a vehicle has an expired token the vehicle is disabled in various ways as are known in the art. These disabling modes could be progressive and keyed to other events like time, miles, tank filling, or signals received by the vehicle. Examples of these disabled modes include
      1. Displaying violation information to the driver
      2. Sending an RF signal that, for example, provides information about the violation with location, etc.
      3. Delays in the amount of time from start of the vehicle to it being operational
      4. Other disabling of functionality from limiting speed to outright inoperability of the vehicle.
   ix. This unlocks a private key in the pump as delivered via some a communication channel such as the wireless or wired channels discussed above. After the payment is made, the pump displays a code that when entered into the vehicle enables operation for a particular time. After the payment code expires, the vehicle enters a specified level of distress mode that could vary from sending an RF signal to limited operation (e.g., 25 miles per hour) to an outright disabling operation.

### III. Embodiments for Plug-in Hybrid Using Both Electricity and Fuel

This case is challenging because both the electrical and fuel systems may be required. If only one system is implemented, the service provider takes a risk that the price of the alternative power (electricity or fuel) will be lower than the price of the supplemented source of power. On the other hand, having access to charging supplements on both electricity and fuel allows the financier to price the two refueling mode according to the value received rather than the commodity cost of goods.

The solutions for the PHEV case, then, require being able to extract additional payment regardless of the mode of refueling the vehicle.
a. One approach is to charge per mile driven. An RF or other communication channel (such as those described above) provides the connection to the financier network and an on board interface ensures a tamper-resistant and/or tamper-evident measurement of miles traveled. This information is compiled periodically (e.g., monthly) and used to charge the supplement.
b. The other approach is to implement both the electricity case and the gas refueling cases above in I. and II. above. In the ideal embodiment, the supplements are billed together.

### IV. Embodiments Using Other Sources of Power

Alternate power systems using compressed air, compressed natural gas, fuel cell powered by other fuels are likely to start with home or business based fueling stations and so are a sort of hybrid between electric and traditional fuel pumping.

In the cases above its assumed that the economic proposition is one of a gas saving innovation that costs extra in up front capital expense. In addition, the embodiments of the invention may be used to implement other economic interactions. Some other capital expense, for example, may be used. For example, implementing a system of derivatives that helps consumers hedge gasoline costs could be translated to price adjustments at the pump.

There are a number of ideas to provide differential billing for vehicle charging based on factors like time of day and whether the vehicle is willing to provide Vehicle to Grid (V2G) power back to the grid during peak load times. The embodiments described herein may be used as a way to implement such pricing schemes. These embodiments have the advantage of a) being outside the existing utility billing system and so away from the constraints of those systems and b) provide a way to implement such a pricing scheme on a nationwide and worldwide basis without getting the cooperation of every utility in each country (there are about 2,000 utilities in the US alone).

In one embodiment of the invention, a solar panel is installed on a user's home or vehicle at a reduced cost. The solar panel includes sensors and circuitry for actively measuring the amount of solar energy provided to the home or vehicle and a communication interface for communicating this information to the financier billing system 304 or the fuel or efficiency provider billing and tracking system 303. As in prior embodiments, the user is charged a supplemental amount based on the amount of solar energy consumed.

Various different computer “systems” are described above. These systems are represented in FIG. 1 by servers 110, 150-152 and in FIG. 3 by systems 301-304. Embodiments of the servers and systems are implemented using one or more of the computing architectures illustrated in FIG. 2. It should be noted, however, that the underlying principles of the invention are not limited to the particular hardware or software configurations described herein. For example, the functionality described above may be implemented on a single server or across multiple networked servers.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while a client-based implementation is described above, a server-based implementation (or other distributed computing implementation) is also contemplated within the scope of the present invention. Accordingly, the scope and spirit of the invention should be judged in terms of the claims which follow.

What is claimed is:

1. A computer-implemented system for reducing the cost of efficient vehicles comprising:
a vehicle equipped with a memory for storing program code and a processor for processing the program code to perform a specified set of operations, the vehicle further comprising a data communication interface;
a fuel pump of electrical charging station having a data communication interface, wherein the fuel pump of electrical charging station and the vehicle establish a digital data communication channel using the data communication interfaces as the vehicle is being refueled or charged;
wherein the fuel pump of electrical charging station provides an amount of fuel or electricity to the vehicle and, after or during fueling or recharging, transmits an indication of the amount of fuel or electricity consumed by the vehicle to a third party server;
wherein the third party server is maintained by a third party having a contractual relationship with an owner/operator of the vehicle in which the vehicle has been provided to the owner/operator at a reduced cost in exchange for an agreement by the owner/operator to provide the third party a supplemental payment based on the amount of fuel or electricity consumed by vehicle, wherein in response to receipt of the indication of the amount of fuel or electric consumed by the vehicle, the third party charges the owner/operator a supplement amount based on the amount of fuel or electricity used by the owner/operator.

2. The system as in claim 1 wherein the specified set of operations performed by the vehicle comprise:
monitoring an amount of fuel or electric consumed by the vehicle;
periodically communicating an indication of the amount of fuel or electric consumed by the vehicle to the third party server over the wired or wireless communication interface,
wherein the third party uses the indication of the amount of fuel or electric consumed by the vehicle to verify that the user has been properly charged for fuel or electric fuel usage.

3. The system as in claim 1 wherein the vehicle further comprises:
a vehicle functionality interlock to limit functionality or disable use of the vehicle upon detecting a specified set of conditions.

4. The system as in claim 3 wherein one of the specified sets of conditions comprises detecting that the user has not paid the supplemental amount to the third party for vehicle consumption of an amount of fuel or electricity.

5. The system as in claim 1 wherein the data communication interfaces comprise wireless communication interfaces and the digital data communication channel comprises a wireless communication channel.

6. The system as in claim 1 wherein the data communication interfaces comprise wired communication interfaces and the digital data communication channel comprises a wired communication channel.

7. A computer-implemented system for reducing the cost of efficient vehicles comprising:
a vehicle comprising:
a data communication interface for connecting the vehicle to a data communication network,
a memory for storing program code and a processor for processing the program code to implement a vehicle usage measurement module actively monitoring one or more variables related to vehicle usage, at least one of the variables comprising an amount of fuel and/or electricity consumed by the vehicle over a specified period of time;
a third party service comprising one or more servers and a user account database for storing data related to the vehicle and a user of the vehicle, the servers having a memory for storing program code and a processor for processing the program code to perform the operations of:
establishing a communication channel with the vehicle over the data communication network;
receiving from the vehicle usage measurement module an indication of an amount of fuel or electricity consumed by the vehicle;
calculating a supplemental usage charge based on the amount of fuel or electricity consumed by the vehicle;
applying the supplemental usage charge to the user account database; and
communicating the supplemental usage charge to the user of the vehicle.

8. The system as in claim 7 wherein the vehicle further comprises:
a vehicle functionality interlock to limit functionality or disable use of the vehicle upon detecting a specified set of conditions.

9. The system as in claim 8 wherein one of the specified sets of conditions comprises detecting that the user has not paid the supplemental usage charge to the third party service for vehicle consumption of an amount of fuel or electricity.

10. The system as in claim 7 further comprising:
a fuel pump or electrical charging station having a data communication interface, wherein the fuel pump of electrical charging station and the vehicle establish a digital data communication channel using the data communication interfaces as the vehicle is being refueled or charged; and
wherein the fuel pump of electrical charging station provides an amount of fuel or electricity to the vehicle and, after or during fueling or recharging, transmits an indication of the amount of fuel or electricity consumed by the vehicle to the third party service.

11. The system as in claim 7 wherein the third party service is maintained by a third party having a contractual relationship with a user of the vehicle, in which the vehicle has been provided to the user at a reduced cost in exchange for an agreement by the user to provide the third party a supplemental payment based on the amount of fuel or electricity consumed by vehicle, wherein in response to receipt of the indication of the amount of fuel or electric consumed by the vehicle, the third party charges the user a supplemental amount based on the amount of fuel or electricity consumed by the vehicle.

12. The system as in claim 7 wherein the data communication interfaces comprise wireless communication interfaces and the digital data communication channel comprises a wireless communication channel.

13. The system as in claim 7 wherein the data communication interfaces comprise wired communication interfaces and the digital data communication channel comprises a wired communication channel.

14. A computer-implemented method for reducing the cost of efficient vehicles comprising:
communicatively connecting a vehicle to a data communication network,
actively monitoring one or more variables related to vehicle usage, at least one of the variables comprising an amount of fuel and/or electricity consumed by the vehicle over a specified period of time;
storing data related to the vehicle and a user of the vehicle within a user account database;
establishing a communication channel with the vehicle over the data communication network;
receiving from the vehicle an indication of an amount of fuel or electricity consumed by the vehicle;
calculating a supplemental usage charge based on the amount of fuel or electricity consumed by the vehicle;
applying the supplemental usage charge to the user account database; and
communicating the supplemental usage charge to the user of the vehicle.

15. The method as in claim 14 further comprising:
limiting functionality or disabling use of the vehicle upon detecting a specified set of conditions.

16. The method as in claim 15 wherein one of the specified sets of conditions comprises detecting that the user has not paid the supplemental usage charge for vehicle consumption of an amount of fuel or electricity.

17. The method as in claim 14 further comprising:
establishing a digital data communication channel between the vehicle and a fuel pump of electrical charging station as the vehicle is being refueled or charged; and
providing an amount of fuel or electricity to the vehicle and, after or during fueling or recharging, transmitting from the fuel pump of electrical charging station an indication of the amount of fuel or electricity consumed by the vehicle to a third party service.

18. The method as in claim 14 wherein the data communication network comprises a wireless data communication network.

19. The system as in claim 14 wherein the data communication network comprises a wired data communication network.
